(19) United States
(12) Patent Application Publication
(10) Pub. No.: US 2015/0371423 A1
(43) Pub. Date: Dec. 24, 2015

(54) Means and methods of transforming a fictional book into a computer generated 3-D animated motion picture ie “Novel's Cinematization”

(71) Applicant: Jerome Robert Rubin, Chester, VA (US)

(72) Inventor: Jerome Robert Rubin, Chester, VA (US)

(21) Appl. No.: 14/311,195

(22) Filed: Jun. 20, 2014

(51) Int. Cl. G06T 13/40; G06T 19/20; G06F 17/21

(52) U.S. Cl. CPC G06T 13/40; G06F 17/211; G06T 19/20; G06T 2219/20

(57) ABSTRACT

A Novel is a written fictional story that hopefully gives the reader a joyful reading experience with the ability to visualize the story depending on the author's expertise. As the story unfolds, with the storyteller's power of the written word, in describing and relating the story's plot and associated scenes that produce images of the characters and of the scenes pictured in the mind of reader. The present invention provides the methodology to apply advanced computer technology that will transform a complete written work to create a computer generated 3-D animated motion picture. A staff of computer operator/designers will be able to process the work to achieve the computer-produced “Novel's Cinematization” [NC].

### CROSS-REFERENCE TO “RELATED U.S. PATENT DOCUMENTS” APPLICATIONS

References cited:

U.S. Patent Documents

| | | |
|---|---|---|
| 8,250,481 | August, 2012 | Klaric, et al. |
| 7,555,724 | June, 2009 | Ho; Seng Beng |
| 7,309,283 | December, 2007 | Nemitz |
| 5,999,172 | December, 1999 | Roach |
| 5,761,485 | June, 1998 | Munyan |
| 5,524,193 | June, 1996 | Covington, et al. |

### OTHER REFERENCES

Product Overview [online]. Autodesk Maya 31) website[retrieved Sep, 24, 2012].

Retrieved from Internet at: http://autodesk.com/maya

Product Overview [inline]. Maxon/3D for the real world website [retrieved Sep. 24, 2012]. Retrieved from Internet at http://www max.on.net/en/products/general-information/

Overview [online]. Computer-generated imagery using computer graphics software website [retrieved May 5, 2008]. Retrieved from internet at: http://thecomposites.tumblr.com/

Product Overview [online]. RenderMan Pro Server website [retrieved Sep. 9, 2012].

Retrieved from Internet at: http://renderman.pixar.com/products/tools/rps.html

Product Overview [online]. FrameForge Previz Studio website [retrieved May 6, 2012].

Retrieved from Internet at: http://www.frameforge3d.com/Products/

Overview [online]. Sketch photo website [retrieved Sep. 6, 2012]. Retrieved from Internet at: http://portraitpad.com/

Product Overview [online] Autodesk Motionbuilder 7.5, Autodesk website [retrieved Oct. 28, 2012]. Retries edfrom Internet at httpllu%Lamodesk.wmiMofionBuilder

Product Overview [online]. FrameForge 3D Studio 2, Storyboard Software The Pro Version of FrameForge Previz Studio 3 [retrieved October 25, 2012]. Retrieved from Internet at: http://frameforge3d.com/index.php?pmc=AW2

Product Overview [online]. Adobe After Effects CS6 Software [retrieved Oct. 25, 2012].

Retrieved from Internet at: http://www.adobe.com/products/aftereffects.html

Product Overview [online]. FinalDraft Software [retrieved on Oct. 25, 2012]. Retrieved from Internet at: http://www.finaldraft.com/index.php

Product Overview . NaturalReader [retrieved Oct. 25, 2012]. Retrieved from Internet at: http://www.naturalreaders.com/sample.php

Product Overview [online]. NextUp.Com [retrieved Oct. 25, 2012]. Retrieved from Internet at: http://www.nextup.com/

Product Overview [online]. Celtx [retrieved Oct. 25, 2012]. Retrieved from Internet at: https://www.celtx.com/index.html

Product Overview [online] LightWave 3D, [retrieved Oct. 25, 2012]. Retrieved from Internet at: http://www.lightwave3d.com/

Product Overview [online] PSK Studios CGI, [retrieved Oct. 26, 2012]. Retrieved from Internet at: http://www.pgkstoudios.com/about-us/

### BACKGROUND OF THE INVENTION

As we read a novel, the storyteller describes and relates the setting, plot, characters, conflict and theme of the story. The reader forms a mental image of the characters and the scenes as the story unfolds. This invention came about while reading several novels and sadly watching the movies based on those stories. Concluding that the Hollywood Movie production of the novel is never as good as the reading of the novel and picturing the elements yourself. Since one of the publishing options is to make a book available unabridged in Adobe PDF format or read by others on either cassette tape or CD. I wanted to be able to see the creative work of the author's as read and pictured in nty imagination with the characters, scenes and plots. I perceived that with today's powerful computer technology and cutting edge creative technologies, you can have computer programs linked together to generate a movie, without all the expense, without any changes and deletions of the content, dialogue, scenes and sub-plots that a Hollywood movie produces. This will enable the reader to watch exactly how the book was written as the author conceived and visualized his story. I decided to patent this method and bring together the technologies enabling the process, The transcription of a novel into a film generated by computer technologies, by computer operator/designers, making the viewer/reader able to see the true cinematic adaptations of novels.

### BACKGROUND ART

An author writes down a sequence of events in a prose narrative that tells a story, intertwine with setting, plot, characters, conflict and theme and ending in the denouement, the conclusion of the plot and hopefully all loose ends are tied up. Only some novels are produced and adopted to film by re-writing to screenplay format and reducing the content of the book to a format to have a movie with a running time of about two hours note that reading the novel i.e. without speed reading, the time is more like twelve hours. With the several changes in details to novel to make into a movie, with no exceptions, most readers believe that the book was better—unless their favorite movie star is in the production with adding incentives. Our imagination is always a step above any movie producer's, director's or screenwriter's conception and time limit considerations. No longer needed is the reader who has waited and anticipated the release of the movie produced and revamped by the studio. The reader is always disappointed with the abridged version whether the novel was read either before or after watching the movie based on the book. The reader has already pictured and envisioned the story with their own mental image of the characters, scenes and plot of the novel.

### BRIEF SUMMARY OF THE INVENTION

A novel is a literary art form that describes fictional or historic characters and events in the form of a story. The concept of the invention is using cutting-edge creative computer technology to develop a computer generated 3-D animated motion picture from a novel. This will be accomplished by using a number of discrete stages (preparation, instructions and final production, with a staff of computer operator/designers to coordinate and to transfer from one medium to a completed “novel cinematization”. This is to secure the concept, characters, story with all the plot structures, dialogue, and action, The film adaptation of novel will be transformed into computer generated 3-D movie. The present invention relates to the field of enhanced computer technology to a multimedia creation and presentation making a perfect parallelism between the novel and film production.

### BRIEF DESCRIPTION OF THE DRAWINGS

Shown is the process's flowchart beginning with the author's novel, then the input of the novel into a computer system demonstrating the various steps of the process producing in the end a computer generated 3-D animated motion picture.

FIG. 1—Commence the process of the computer-produced “Novel's Cinematization” [NC].

FIG. 2—The process uses a computer program to convert and transfer the novel's written contents into an Adobe Portable Document Format (PDF).

FIG. 3—Another separate computer program next transform the story (setting, plot, characters, conflict and theme), verbatim, into a manageable, adaptable screenplay.

FIG. 4—A complement computer program further adopt the screenplay into the “storybook” form, which produces the chronological sequence of distinct events and scenes in specific order as each occur in the novel.

FIG. 5—With an additional computer program documenting the characters and the characters' profile from author's description and use of computer profiling techniques to produce life like 3-D portrait of those characters.

FIG. 6—A method and system provided by a specialized computer program to a suitable match of the character's voice to be used in computer generated motion picture. This match can be reviewed and approved by author. The viewer/reader, if so deemed, also has the ability to change the appearance and to change the voice to match their interpretation of the characters.

FIG. 7—The above system then provided by a specialized computer program to include computer-generated dialogue of the narrative and exposition that the author uses to communicate and convey information of the story to the reader.

FIG. 8—A group of computer-aided design operators then, using the application of specialized computer graphics produce the interactive computer-based imagery in the storytelling to create the scenes of the geographic areas, locales, landscapes or special effects as described in the author's story.

FIG. 9—The designers of this complex production insert the computer generated characters which will interact with the computer generated scenes and sound effects of the story. Also have the ability for the introduction of sound and music to accommodate the enjoyment of the story allowing the user to review the sounds of all the action, movement, and contrast in novel.

FIG. 10—Means of enabling the viewer/reader to choose to either have the words of the novel scrolling at the bottom of the screen or not.

FIG. 11—Means of enabling the viewer/reader that during the movie presentation if any word of the dialogue is unknown' to have the ability to stop the movie to find the definition of that word.

FIG. 12—Also have the viewer/reader the capability that dining the movie presentation to stop the movie and be able to search and look up and review the history or location of a particular scene.

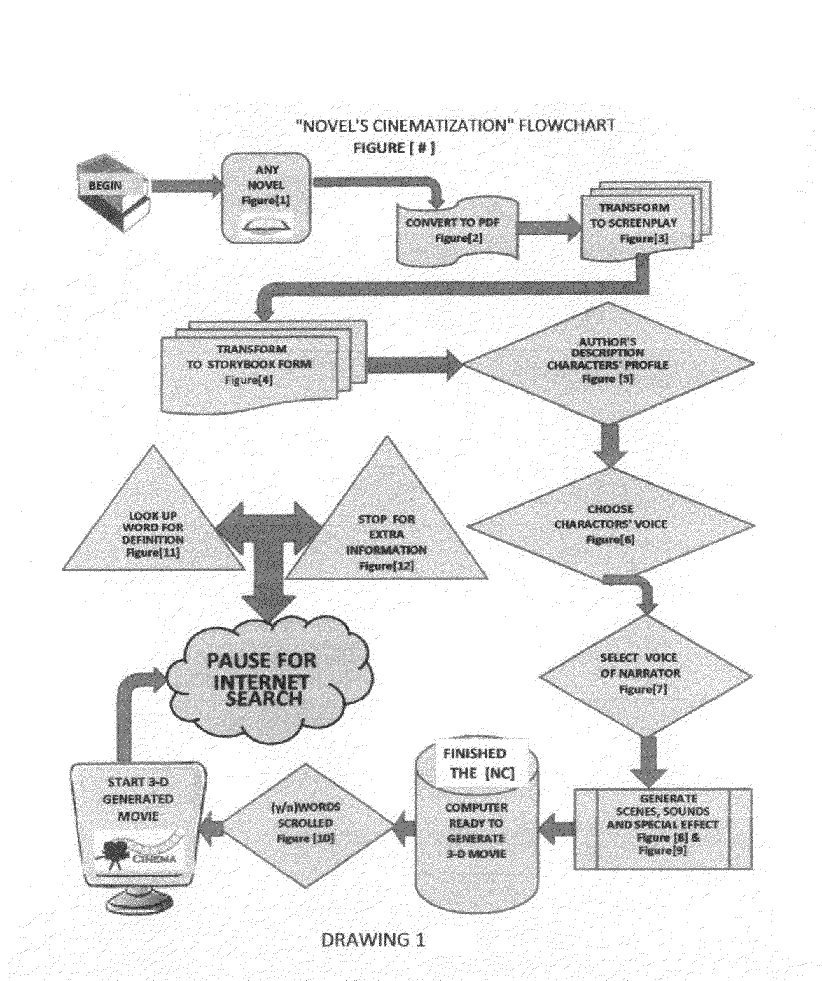

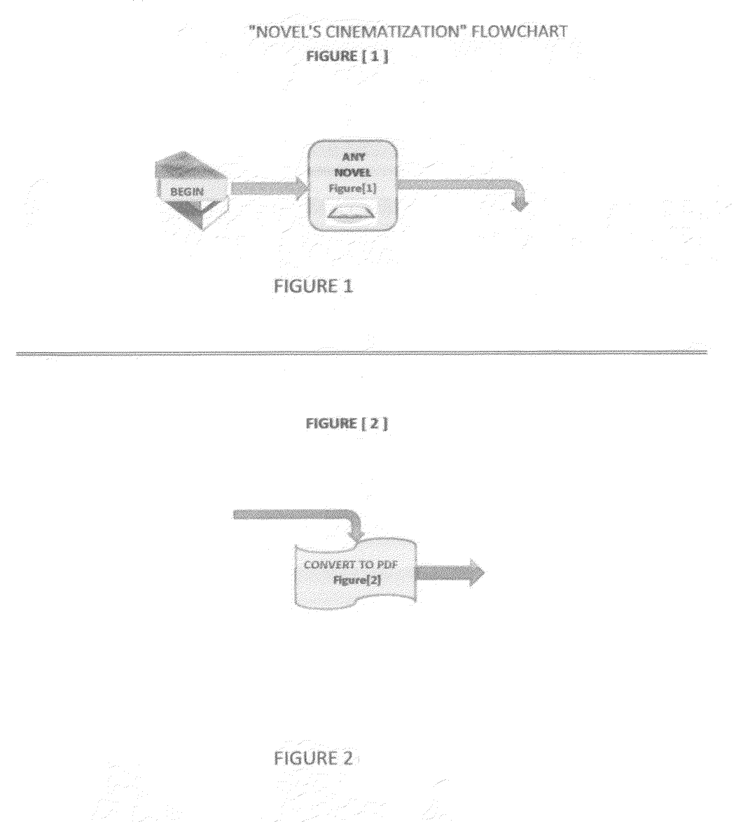

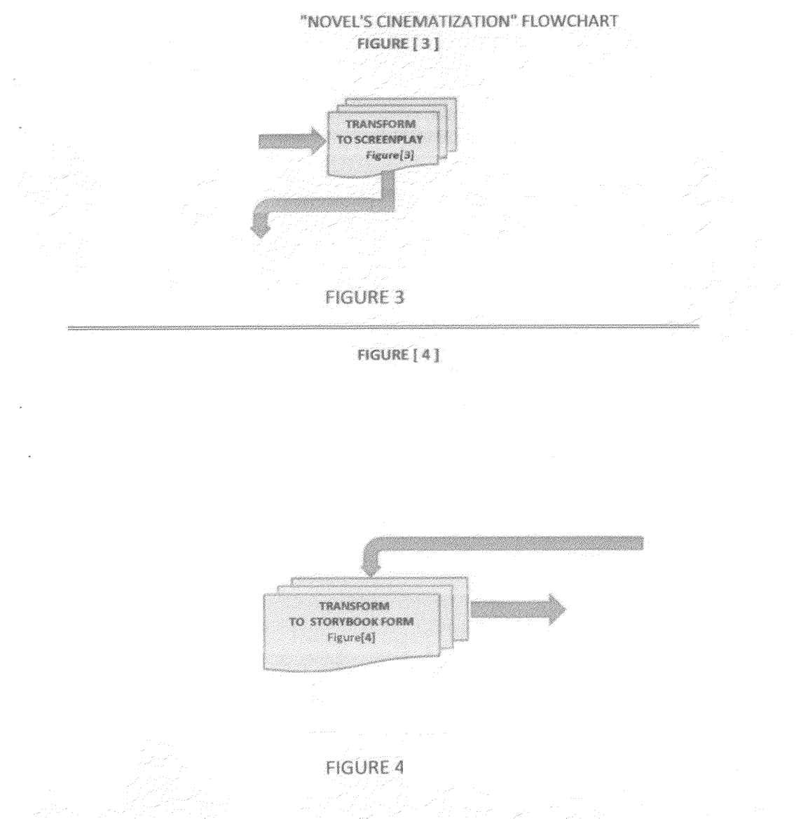

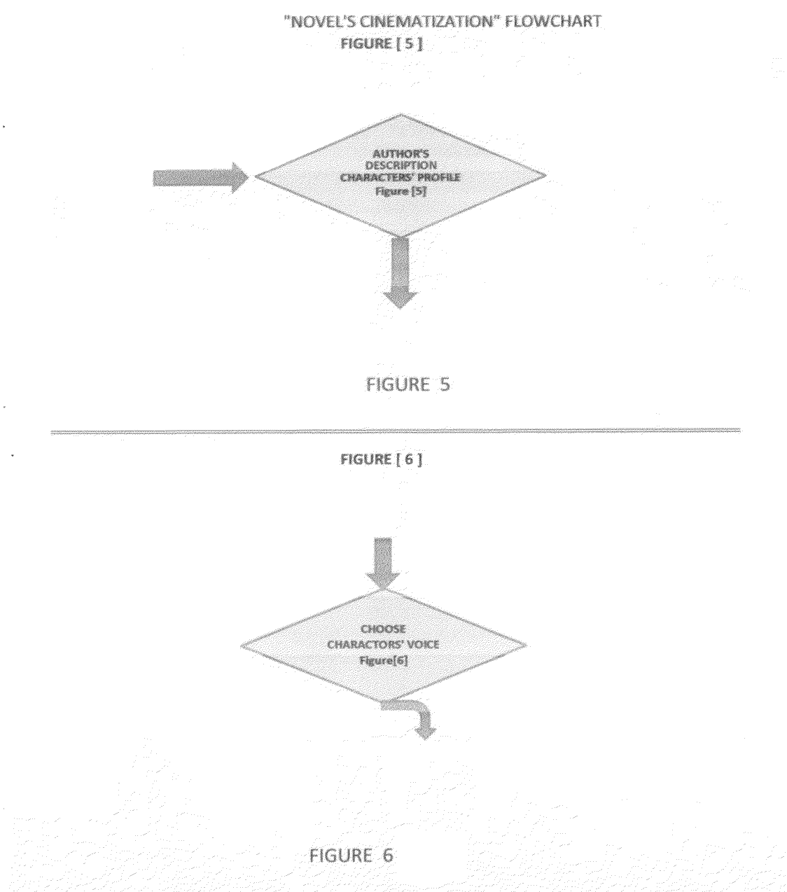

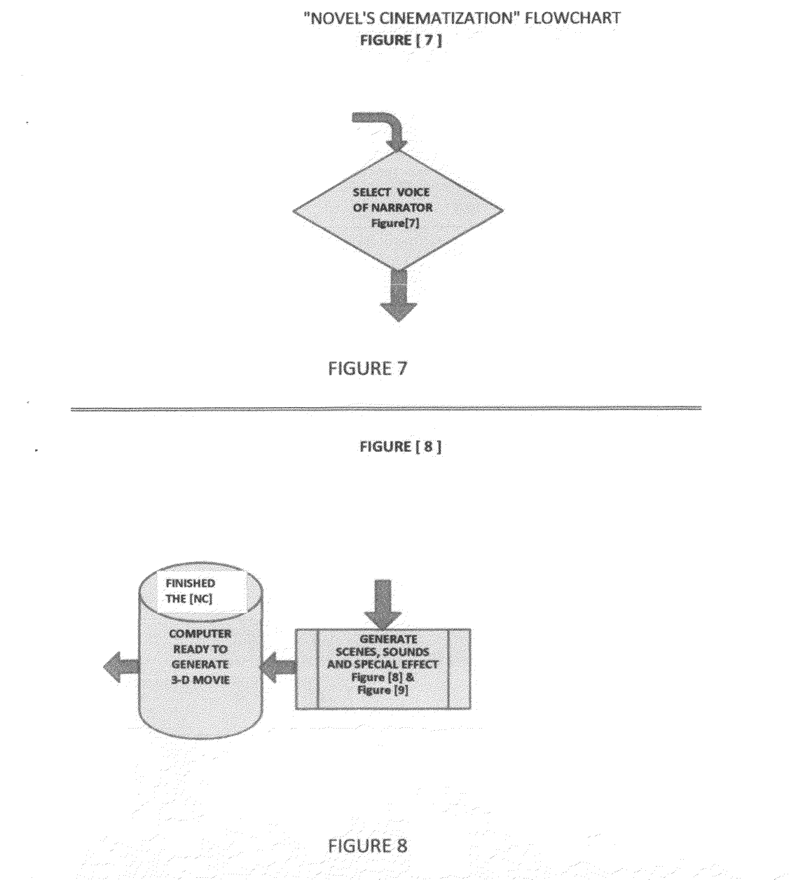

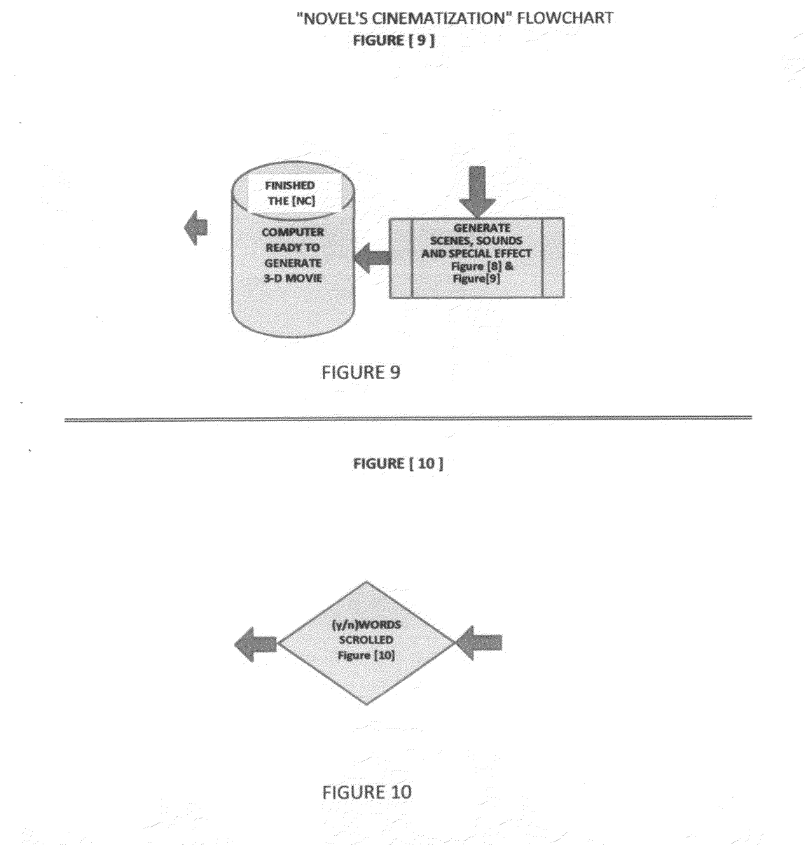

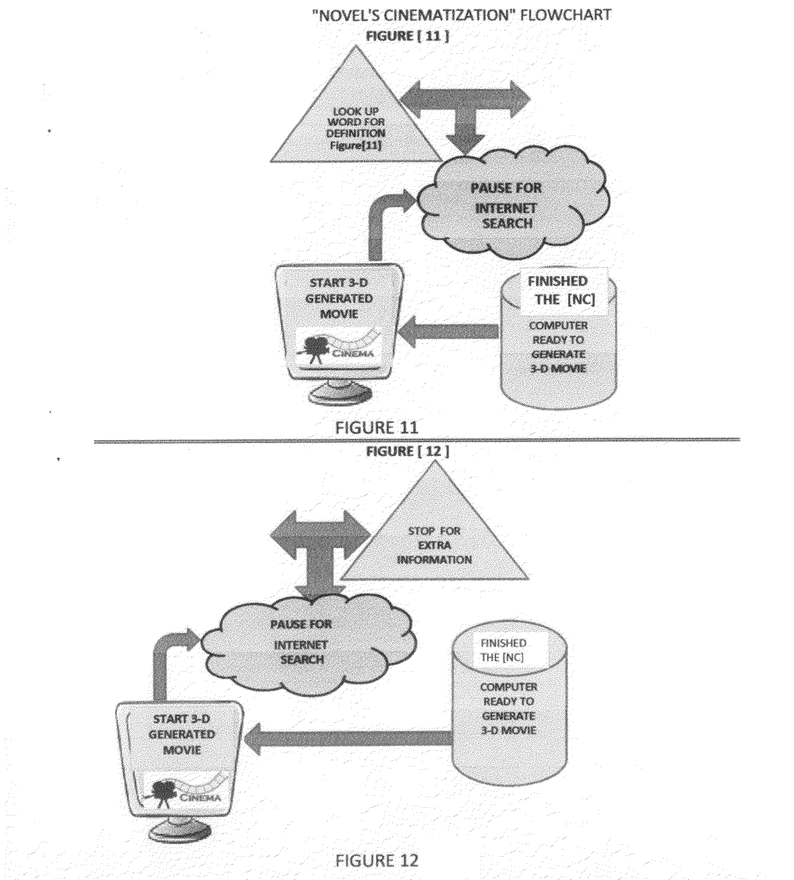

### DETAILED DESCRIPTION OF THE INVENTION

This invention provides a unique design using varies computer software programs to interface with and to produce a programmed system that will adopt and transform a complete original written novel into the creation of a computer generated 3-D animated motion picture. And this will be accomplished, without any changes in details, to the novel the author so careful and meticulous crafted. Now that digital technology can produce all the dramatization, scene imagery and dimensions of the story, i.e. concept, characters and dialogue, story with plot structures, and action. A method is developed for transcribing a novel into format that will enable the computer system to generate a verbatim scene-by-scene screenplay. Then with this formatted screenplay, which preserves the underlying structure of the novel, enables the computer program to next convert to a storybook form, in order to organize each scene in sequence to complete the transformation to prepare to computerize and to generate 3-D animated motion picture. This new entire methodology of integrating computer technologies will revolutionize the way people read and at the same time view novels, enriched with the increasing sophistication and realism of 3-D animation.

After acquiring of the film rights with an agreement with the novel's author and the publisher authorizing the Operation [NC] to create the computer-produced “Novel's Cinematization”

The unique detailed process can now begin by the team of computer operator/designers to transform the novel into a computer generated 3-D animated feature film. The filmmaking operation involves a number of discrete stages, some to create innovative and creative designs for the movie.

The first step of the preparations process by the computer operator/designer is downloading the novel's contents into application software and transferring contents to the Adobe Portable Document Format (PDF). Next is to complete the transformation of the story, now formatted in PDF, into a screenplay format, in which the software breakdown and prepares an outline of the novel into mutually exclusive categories of all the key elements. With the novel now in the screenplay format, another computer program lists the complete cast of characters with dialogue in conjunction with the list of each scene as it occurs in the story.

Next procedure is to use sophisticated profiling software. With the inclusion of the complete list of characters (major and minor) and the author's profiles are listed for each character, will enable the computer operator/designer the capability, using menu choices, to choose the characters' profile as close as possible with the author's descriptions of those literary characters the author so eloquently developed. With this extraordinary rending technology, this will give an operator the opportunity to choose the pictures and physical appearance of each character and to match with characters' personalities and demeanor used in this computer-generated 3-D animated motion picture. These virtual characters, using computer-generated characters profiles, will be so lifelike and convincingly real.

As the computer-generated 3-D animated motion picture is begun, there will be a brief introduction of the characters, showing their image and dialogue. If determined in the movie as shown, the viewer/reader is not satisfied with any character image or physical appearance could also generate the character image, if author description is too vague. The viewer/reader also has the opportunity to stop the movie and change the character profile, if viewer/reader. deems necessary. Generating a more complete picture of the character's face and body to suit the user impression and not what the author had intended. The possibility of having the author approve a character's image is also may be acquirable.

Next is to match the voices with each character's profile from list of voices from software dedicated to this application of computer-generated dialogue. As computer operator/designer elects the type of voice that is the best fit for each character and/or characterizations to match the author's description and hopefully what the author had intended. (To take into account the particular accents or tones of voice's used and what emphasis these words might mean—socially or temperamentally).

With the voices of each character selected, the next step is determining what mode of narration is used for the storytelling. There are various ways the story is conveyed to the reader. How the author communicates the written novel to the reader could be in first-person view, second-person view or third-person narrative or even an alternating person view. The computer operator/designer selects the type of voice and gender that is the best fit for the narrator. With the above preliminary steps outlined above now completed, the use of several specialized applications software programs is now introduced The computer operator/designer now has the ability to manage and integrate the unique computer-generated imagery's capabilities to complete the cinematization of the novel [NC].

Now the task of the input of computer-generated imagery for each scene that the author conjured up in the novel needs is to be created. A collection of digital images of various scenes can be retrieved from current database or with the meticulous ability of the computer operator/designer to generate the 3-D digital images of other scenes yet to be included in digital images database. This is the most complicated task of the process and the most important component in creating the convincing final renderings.

The novel now transformed from the PDF format into the screenplay and finally into a storybook configuration. The staff of computer operator/designers has the scenes organized and now able to produce the digital images in order to develop each scene as listed and described. This sequence of events as it occurs in storyline capturing each second of story's events of all the action, movement and incidences as described by the novelist.

This team of computer operator/designers will work on a multitude of tasks to ensure the efficiency and accuracy of the computer generated 3-D animated motion picture. The computer operator/designers will have the responsibility to monitor and to manage a group of computer software programs and have to control the factors that are required for the efficient working of all systems.

With two basic kinds of computer animation: computer-assisted and computer-generated.

Either method will generate visual scenes with 2-D or 3-D images, using computer graphics software to create the visual representation of a scene to match the author's depictions. These visual scenes of the background could be either static or dynamic. Some scene images could visualize the different geographic areas of the world.

The technique used by the computer operator/designers to integrate with other applications by using the latest technology of computer graphics software to create and produce the scene sequences with other various objects and settings that the author's imagination has introduced in his story. The novel has a profusion of action sequences; in different locales and having the characters engaged in all sorts of actions and discourse. Using computer-generated imagery applications, the computer operator/designers create the visual effects and sound effects with the 3-D computer graphics images of the characters, the environments, and other elements. These components are brought together to produce, accurately, the author's descriptions and creative vision and artistic merits concerning events, landscapes or special, effects of various action scenes directly to the screen. With all the stages and elements completed, the computer generated 3-D animated motion picture is ready for the viewer/reader to behold this computer produced “Novel's Cinematization” [NC].

Now with everything aspect of the transformation in exact order and completed, the finished production is ready for viewing. The viewer/reader has the ability, if so desired, to personalize the “Novel's Cinematization” [NC]. This ability for the user customization of the production based on the reader's visualization of what he reads. Since the viewer/reader imagination maybe in conflict with the author's version as read and now viewed, the independent reader/viewer when reading/viewing the novel may disagree with author's vision or interpretation on the information about action, characters, atmosphere, ideas, and the mode of presentation that contributes to the impression received. if the viewer/reader wish to change or adjust some element in the “Novel's Cinematization” [NC], they have the program control and ability to do just that.

If deemed necessary and requested by viewer/reader, all sound elements can he designed and recorded. Then sound can be then added, i.e. sound effects to credibly “visual” effects are digitally added and a sic score for soundtrack, if required.

Also available to reader/viewer of the computer generated 3-D animated feature film is the choice of having the bottom portion of screen scrolling the words of the transcript of the novel as the movie is shown. This is accomplished by automatically generating a closed-captioning of text either the conversations or the narrative, As one is ‘reading’ of the film text along with listening.

Also if a word is unknown the viewer/reader has the ability to stop the movie and connect to internet dictionary to look up the definition of that word.

Also the reader/viewer will also be the ability to stop the movie to deem more information about the story. Web hyperlinks will be available to connect with the interne with the links about the places in the scene or some facts in which viewer/reader wants more information or to verify the facts or myths. That will help the viewer/reader with important information or imagery and create a truly interactive environment.

What claim is:

1. Methods comprising: transformation of an author's novel in its entirety, with customized and unique computer programs, to generated 3-D motion picture i.e “Novel's Cinematization” [NC], hence, to enhance the reader's experience and imagination to actual visual presentation without disturbing authors original intent. To bring the images as author intended to visualization and imagination brought to life. A claimed by prior art as anticipated and described by Franceus (US2012/0105454 A1) does not influence this patent an important distinction, in which uses storage media and data processing in different aspects of producing total scenes of graphic images.

2. A method comprising: the gathering and compiling in a distinctly new process of using computer programs to convert a novel, in it entirety, and transferring contents to a format enabling integrated computer programs to produce a unique computer generated 3-D motion picture entirely based on every words, in every sentence and adopt to this computer generated motion picture. A claimed by prior art as described and disclosed by Ho (U.S. Pat. No. 6,407,757 B1), this patent an important distinction by generates and displays each scene and dialogue exactly as the author had wrote, not just displaying set of information in book form by flipping of pages

3. A method wherein an application is available with a unique structured function on a keyboard (i.e., two select key strokes) to enabling a reader the distinct ability to become an active participant to view the movie presentation of written works by enhance computer technology. A claimed by prior art as described and disclosed by Hemmings US2008/0256479 A1, this patent has an important distinction that is not just animation of pictures or activation and display pages turning, by use of technology, actual images produce the movie presentation.
